(19) United States
(12) Patent Application Publication
(10) Pub. No.: US 2026/0331597 A1
(43) Pub. Date: Oct. 22, 2026

(54) SMART BATTERY MANUFACTURING METHOD

(71) Applicants: CPS Technology Holdings LLC, New York, NY (US); Clarios Germany GmbH & Co. KG, Hannover (DE)

(72) Inventors: Torsten GRETH, Wunstorf (DE); Gerardus C. ZWEGERS, Alamosa, CO (US); Bruce D. MACLACHLAN, Seneca, SC (US); Gary GRAMER, Alexandria, KY (US); Jeffrey L. TROXEL, Menomonee Falls, WI (US); Jason D. FUHR, Sussex, WI (US); Arunraj VARATHARAJAH, Menomonee Falls, WI (US); Rengaraj BALAKRISHNAN, Raleigh, NC (US); Joseph E. LIEDHEGNER, Wauwatosa, WI (US)

(21) Appl. No.: 19/122,083

(22) PCT Filed: Oct. 18, 2023
(86) PCT No.: PCT/US2023/077175

§ 371 Date: Apr. 17, 2025

Related U.S. Application Data
(60) Provisional application No. 63/417,175, filed on Oct. 18, 2022.

(51) Int. Cl. H01M 10/12; B60R 16/02; B60R 16/033

(52) U.S. Cl. CPC H01M 10/12; B60R 16/0207; B60R 16/033; H01M 2220/20

(57) ABSTRACT

A method for assembling a battery is described. The battery has a case, a post assembly, a plurality of battery cells, and a first cover. The post assembly includes a plurality of posts. The first cover has a first plurality of openings. The method includes assembling the case, the post assembly, and the plurality of battery cells. The assembling includes coupling the post assembly to the plurality of battery cells by coupling each post of the plurality of posts to a corresponding battery cell of the plurality of battery cells and inserting the plurality of battery cells and the post assembly in the case. The method further includes coupling the first cover to the case. At least one post of the plurality of posts protrudes through at least one opening of the first plurality of openings and extends from the first cover.

### TECHNICAL FIELD

This disclosure relates to batteries and in particular to manufacturing and/or assembly of a smart battery to facilitate battery performance/failure monitoring.

### BACKGROUND

As battery technology evolves, the demand for improved power sources such as energy storage modules for vehicles continues to grow. Existing battery systems, for example lead acid battery systems, typically offer limited access to performance and failure monitoring. More specifically, existing lead acid battery systems may not be capable of providing one or more battery parameters (e.g., usable to determine performance and/or predict/monitor failure) of one or more battery cells of the lead acid battery system. In other words, it is difficult for existing lead acid battery systems to provide information about vital components, such as the state of health of the individual battery cells. Accordingly, the state of health of battery cells cannot be monitored and/or determined, thus hindering the ability to predict upcoming battery failure or the onset of failure.

### SUMMARY

Some embodiments advantageously provide a method of manufacturing and/or assembling a smart battery. In some embodiments, the method may include one or more of the following: assembling a case and one or more battery cells; performing at least one of a filling and a formation of the battery; and performing at least one of a first electronic assembly and a second electronic assembly. In some other embodiments, a battery management system (BMS) is connected to one or more components of a lead assembly which may be connected to one or more posts and/or cells, e.g., to determine/measure at least one parameter, such as cell voltage, current, temperature, etc. In some embodiments, the BMS, lead assembly, posts, and/or bushings are assembled/manufactured in a battery, e.g., without having to change one or more specifications of the battery.

According to one aspect, a method for assembling a battery is described. The battery has a case, a post assembly, a plurality of battery cells, and a first cover. The post assembly includes a plurality of posts. The first cover has a first plurality of openings. The method includes assembling the case, the post assembly, and the plurality of battery cells. The assembling includes coupling the post assembly to the plurality of battery cells by coupling each post of the plurality of posts to a corresponding battery cell of the plurality of battery cells and inserting the plurality of battery cells and the post assembly in the case. The method further includes coupling the first cover to the case. At least one post of the plurality of posts protrudes through at least one opening of the first plurality of openings and extends from the first cover.

In some embodiments, the method further includes performing a filling of the battery.

In some other embodiments, the first cover further includes a second plurality of openings, and performing the filling of the battery includes inserting one or more bottles in one or more openings of the second plurality of openings and discharging bottle contents into the case.

In some embodiments, performing the filling of the battery further includes removing the one or more bottles and covering the plurality of second openings.

In some other embodiments, the battery further includes a lead assembly, and the method further includes at least one of placing the lead assembly on the first cover and coupling the lead assembly to the at least one post of the plurality of posts.

In some embodiments, the battery further includes a battery management system (BMS) and one or more terminals. The method further includes placing the BMS on the battery and coupling the BMS to the at least one of one or more terminals and to the lead assembly.

In some other embodiments, the lead assembly includes a plurality of leads, each lead comprising a first end and a second end opposite the first end, and coupling the lead assembly to the at least one post includes coupling the first end of at least one lead to the at least one post, and coupling the BMS to the lead assembly includes coupling the second end of the at last one lead to the BMS.

In some embodiments, the battery further includes a wiring harness and a vehicle connector, and the method further includes connecting the wire harness to the BMS and to the vehicle connector.

In some other embodiments, the battery further includes a second cover, and the method further includes coupling the second cover to first cover.

In some embodiments, the battery further includes a third cover and one or more terminal caps. The second cover includes an access opening. The method further includes at least one of coupling the third cover to the second cover, where the third cover covers the access opening of the second cover, sealing the third cover to second cover; and coupling the one or more terminal caps to the first cover.

In some other embodiments, the battery is a lead acid battery.

According to one aspect, a method for assembling a battery is described. The battery has a case, a post assembly, a plurality of battery cells, a lead assembly, and a first cover. The post assembly includes a plurality of posts. The first cover has a first plurality of openings. The method includes assembling the case, the post assembly, and the one or more battery cells, where the assembling includes coupling the post assembly to the plurality of battery cells by coupling each post of the plurality of posts to a corresponding battery cell of the plurality of battery cells and inserting the plurality of battery cells and the post assembly in the case. The method further includes coupling the first cover to the case. At least one post of the plurality of posts protrudes through at least one opening of the first plurality of openings and extends from the first cover. In addition, the lead assembly is coupled to the at least one post of the plurality of posts.

In some embodiments, the method further includes performing a filling of the battery.

In some other embodiments, the first cover further includes a second plurality of openings, and performing the filling of the battery includes at least one of inserting one or more bottles in one or more openings of the second plurality of openings, discharging bottle contents into the case, removing the one or more bottles, and covering the plurality of second openings.

In some embodiments, the battery further includes a battery management system (BMS) and one or more terminals. The method further includes placing the BMS on the battery and coupling the BMS to the at least one of one or more terminals and to the lead assembly.

In some other embodiments, the lead assembly includes a plurality of leads, each lead comprising a first end and a second end opposite the first end, and coupling the lead assembly to the at least one post includes coupling the first end of at least one lead to the at least one posts, and coupling the BMS to the lead assembly includes coupling the second end of the at last one lead to the BMS.

In some embodiments, the battery further includes a wiring harness and a vehicle connector, and the method further includes connecting the wire harness to the BMS and to the vehicle connector.

In some other embodiments, the battery further includes a second cover, and the method further includes coupling the second cover to first cover.

In some embodiments, the battery further includes a third cover and one or more terminal caps, the second cover includes an access opening, the method further includes at least one of coupling the third cover to the second cover, where the third cover covers the access opening of the second cover, sealing the third cover to second cover, and coupling the one or more terminal caps to the first cover.

According to one aspect, a method for assembling a battery is described. The battery has a case, a post assembly, a plurality of battery cells, a lead assembly, a battery management system (BMS), one or more terminals, and a first cover. The post assembly includes a plurality of posts. The first cover has a first plurality of openings. The method includes assembling the case, the post assembly, and the one or more battery cells. The assembling includes coupling the post assembly to the plurality of battery cells by coupling each post of the plurality of posts to a corresponding battery cell of the plurality of battery cells and inserting the plurality of battery cells and the post assembly in the case. The method further includes coupling the first cover to the case, where at least one post of the plurality of posts protrudes through at least one opening of the first plurality of openings and extends from the first cover. I addition, the method includes placing the lead assembly on the first cover, coupling the lead assembly to the at least one post of the plurality of posts, and coupling the BMS to the at least one of one or more terminals and to the lead assembly.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 shows an example battery and one or more components of the example battery according to the principles of the present disclosure;

FIG. 2 shows an example battery (e.g., exploded view) and one or more components of the example battery according to the principles of the present disclosure;

FIG. 3 shows an example battery manufacturing process according to the principles of the present disclosure;

FIG. 4 shows an example battery manufacturing process including assembly steps according to the principles of the present disclosure;

FIG. 5 shows an example battery manufacturing process including other assembly steps according to the principles of the present disclosure;

FIG. 6 shows an example battery manufacturing process including filling and formation steps according to the principles of the present disclosure;

FIG. 7 shows an example battery manufacturing process including electronic assembly steps according to the principles of the present disclosure;

FIG. 8 shows an example battery manufacturing process including other electronic assembly steps according to the principles of the present disclosure;

FIG. 9 shows an example battery manufacturing process including some other electronic assembly steps according to the principles of the present disclosure;

FIG. 10 shows an example battery manufacturing process including cover assembly steps according to the principles of the present disclosure;

FIG. 11 shows an example battery manufacturing process including other cover assembly steps according to the principles of the present disclosure;

FIG. 12 shows another example battery manufacturing process including some assembly steps according to the principles of the present disclosure;

FIG. 13 shows another example battery manufacturing process including filling and formation steps according to the principles of the present disclosure;

FIG. 14 shows another example battery manufacturing process including electronic assembly steps according to the principles of the present disclosure;

FIG. 15 shows another example battery manufacturing process including other electronic assembly steps according to the principles of the present disclosure;

FIG. 16 shows another example battery manufacturing process including some other electronic assembly steps according to the principles of the present disclosure;

FIG. 17 shows another example battery manufacturing process including cover assembly steps according to the principles of the present disclosure;

FIG. 18 shows example assembly steps of the example battery manufacturing process according to the principles of the present disclosure;

FIG. 19 shows an example method of assembling a battery according to some embodiments of the present disclosure;

FIG. 20 shows an example method of assembling a battery according to some embodiments of the present disclosure; and

FIG. 21 shows an example method of assembling a battery according to some embodiments of the present disclosure.

### DESCRIPTION

As battery technology evolves, there is a need to provide improved power sources, and more efficient and cost-effective methods for manufacturing such power sources as compared to conventional systems and methods.

Accordingly, embodiments described and shown herein provide a battery and method of assembly of the battery that allow smart features to be integrated within a battery that, in some embodiments, can take the same general shape and form as batteries that do not offer “smart” battery features, such as (as a non-limiting example) the ability to monitor individual cell voltages. In some embodiments, at least one lead to a corresponding battery cell may be connected to a battery management system (BMS), e.g., to determine/measure at least one parameter, such as cell voltage, cell current, cell temperature, etc.

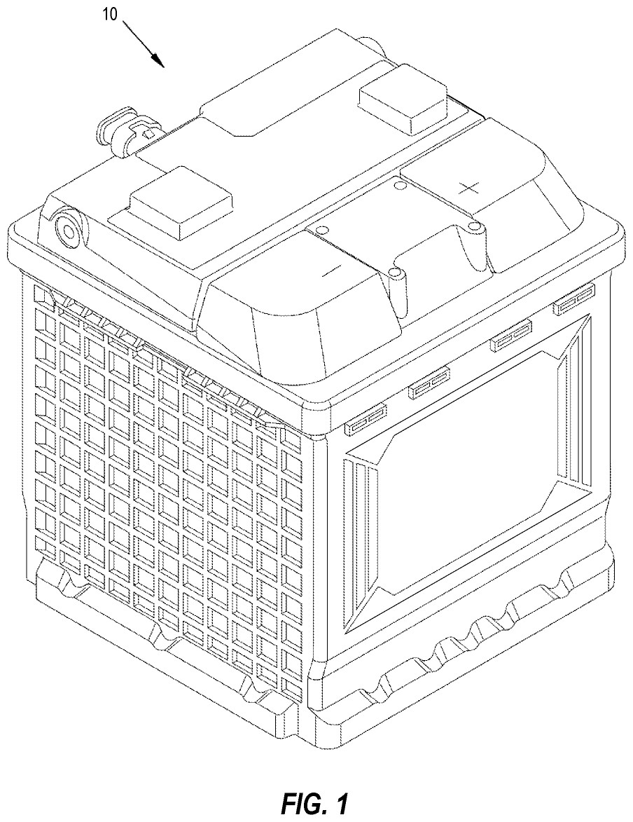

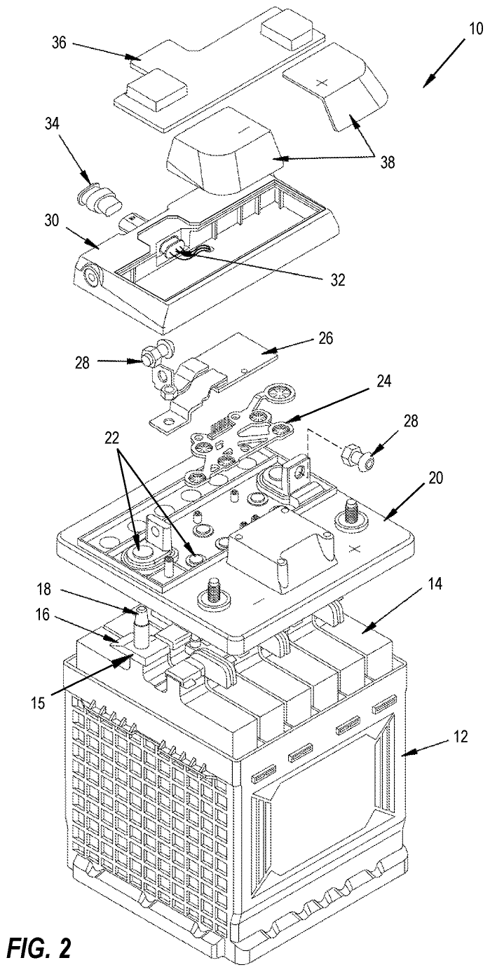

FIGS. 1 and 2 show an example battery (e.g., a lead acid battery having a smart Absorbent Glass Mat (AGM) battery assembly) and one or more components of the example battery. Battery 10 may include at least one of the following: a case 12 (which may be made of from a resin or any other suitable material), one or more battery cells 14, a post assembly 15 (e.g., Cast-On-Strap (COS) post assembly), one or more straps 16, one or more posts 18 (e.g., a terminal post, a mini-post), a first cover 20, one or more bushings 22 (e.g., a U1 bushing, a mini-bushing), a lead assembly 24 (e.g., a lead frame), a battery management system (BMS) 26 (e.g., including a board), one or more fasteners 28, a second cover 30, a wiring harness 32, a vehicle connector 34, a third cover 36, and one or more terminal caps 38. Post assembly 15 may include the one or more straps 16 coupled to the one or more posts 18. In some embodiments, case 12 may be referred to as a housing.

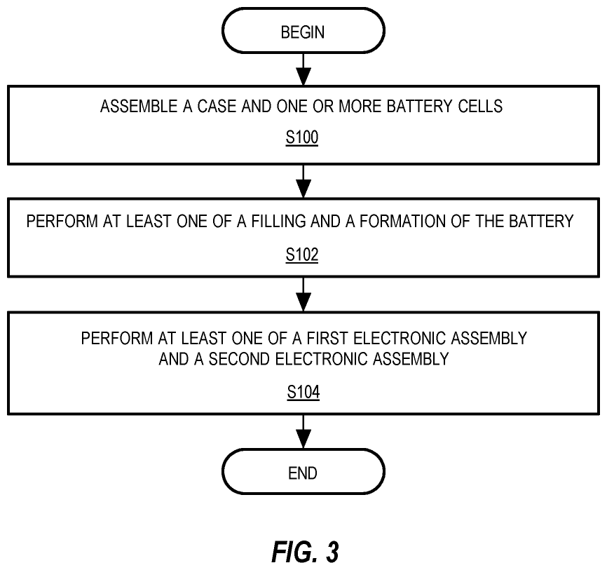

FIG. 3 shows an example battery manufacturing process (i.e., a method) according to the principles of the present disclosure. The method includes one or more of: assembling (Block S100) a case 12 and one or more battery cells 14; performing (Block S102) at least one of a filling and a formation of the battery 10; and performing (Block S104) at least one of a first electronic assembly and a second electronic assembly.

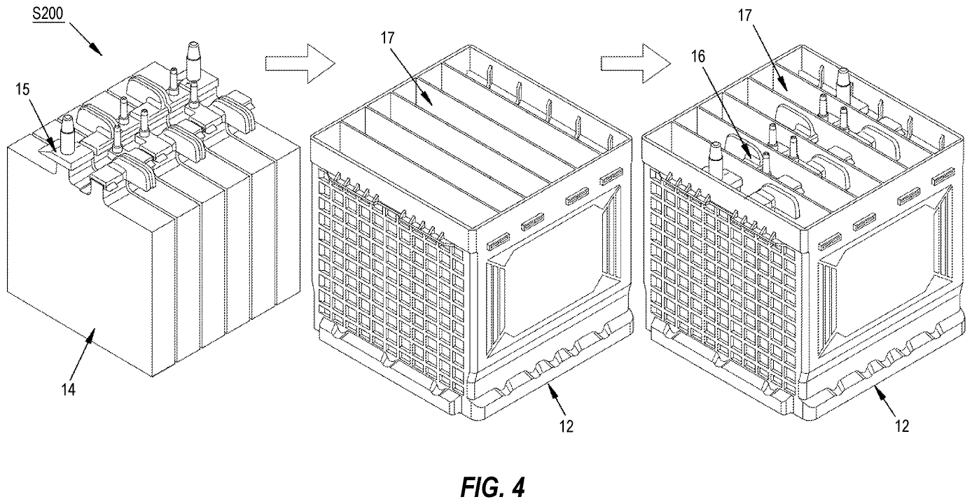

FIG. 4 shows an example battery manufacturing process including assembly steps according to the principles of the present disclosure. At step S200, one or more battery cells 14 are provided. The battery cells 14 may include post assembly 15. Post assembly 15 may be arranged to provide an electrical/physical connection between at least one battery cell 14 and at least one post 18. The battery cells 14 may be inserted in case 12. Case 12 may include one or more separators 17 which may define a volume between each separator 17. Inserting the battery cells 14 may include inserting one or more battery cells 14 between one or more separators 17, i.e., where each battery cell 14 is housed in a volume defined by two contiguous separators 17.

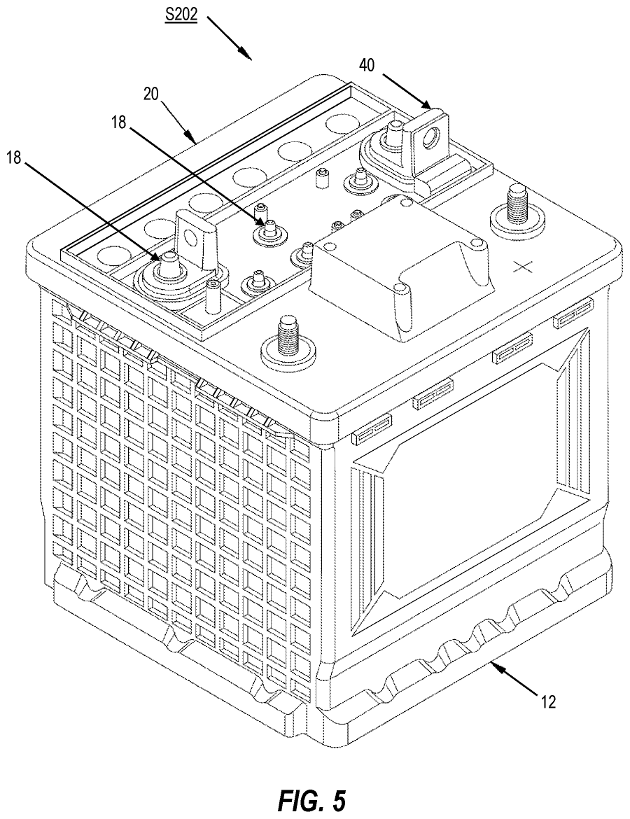

FIG. 5 shows other assembly steps of the example battery manufacturing process according to the principles of the present disclosure. The process may include, at step S202, placing and/or securing first cover 20 on case 12. Cover 20 may be aligned with at least one edge of casing 12. Posts 18 may be arranged to protrude through openings of first cover 20 and extend away from first cover 20. Securing first cover 20 on case 13 may include sealing first cover 20 to case 12 and/or separators 17, e.g., such that battery cells 14 are housed in a sealed space. Step S202 may be performed after step S200. In some embodiments, steps S200 and/or S202 may be part of S100 of FIG. 3.

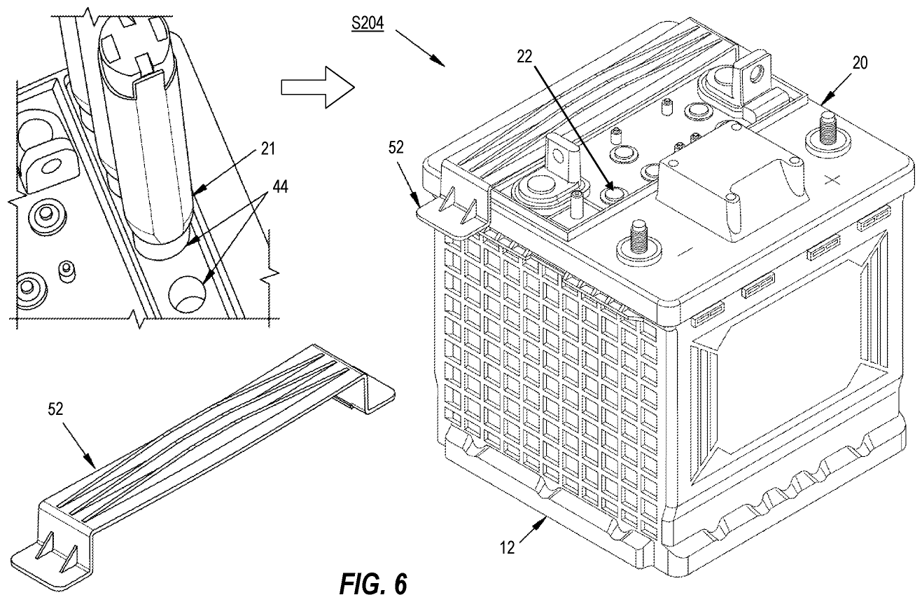

FIG. 6 shows example filling and formation steps of the example battery manufacturing process according to the principles of the present disclosure. At step S204, bushings 22 may be coupled to posts 18 (shown in FIG. 5), which may also prevent fluid communication between the exterior environment and the interior of case 12. Further, one or more bottles 21 may be inserted in one or more cover openings 44 and/or the contents of the bottles 21 (e.g., an electrolyte such as sulfuric acid) may be discharged (e.g., released, poured, etc.) into case 12 and/or battery cells 14 and/or the volume defined by pairs of separators 17, shown in FIG. 4. Step S204 may further include removing the bottles 21 and/or placing in-process cover 52 on first cover 20. Placing in-process cover 52 on first cover 20 may include covering and/or sealing openings 44, e.g., to isolate the contents of case 12 (c.g., electrolyte and/or battery cells 14) from an exterior environment, to prevent the electrolyte from spilling out of case 12, prevent matter from entering the interior of case 12 while battery 10 is being manufactured, etc. Step S204 may be performed after step S202. In some embodiments, step S204 may be part of step S102 of FIG. 3. It is understood that other arrangements may be used for dispensing the electrolyte into the interior of case 12 and/or the volume defined by separators 17, e.g., using a hose/tube/funnel, etc., to pour the electrolyte into the interior of case 12 and/or the volume defined by separators 17.

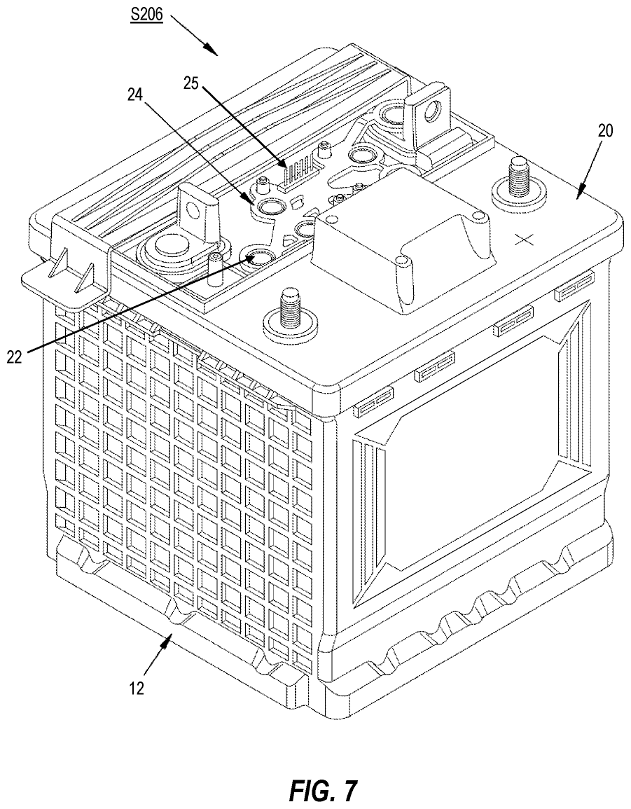

FIG. 7 shows example electronic assembly steps of the example battery manufacturing process according to the principles of the present disclosure. At step S206, lead assembly 24 may be placed on first cover 20 and/or connected to at least one bushing 22 and/or post 18. Placing lead assembly 24 on first cover 20 and/or connecting lead assembly 24 to at least one bushing 22 and/or post 18 may include aligning lead assembly 24 with one or more components of battery 10, e.g., bushings 22, and/or inserting (and/or coupling to) one or more portions of lead assembly 24 in one or more components of battery 10 (e.g., first cover 20) and/or vice versa. Lead assembly 24 may be arranged to couple (e.g., electrically/physically couple) to a plurality of bushings 22 and a plurality of posts 18 (shown in FIG. 4) and battery cells 14 (shown in FIG. 4). More specifically, lead assembly 24 may include a plurality of leads 25, where each lead 25 has a first end and a second end opposite the first end. The first end of each lead 25 may be arranged to establish a physical and/or electrical connection to a BMS 26 and the second end to a battery cell 14, via bushings 22, post 18, etc. Step S206 may be performed after step S204. In some embodiments, step S206 may be part of step S104 of FIG. 3.

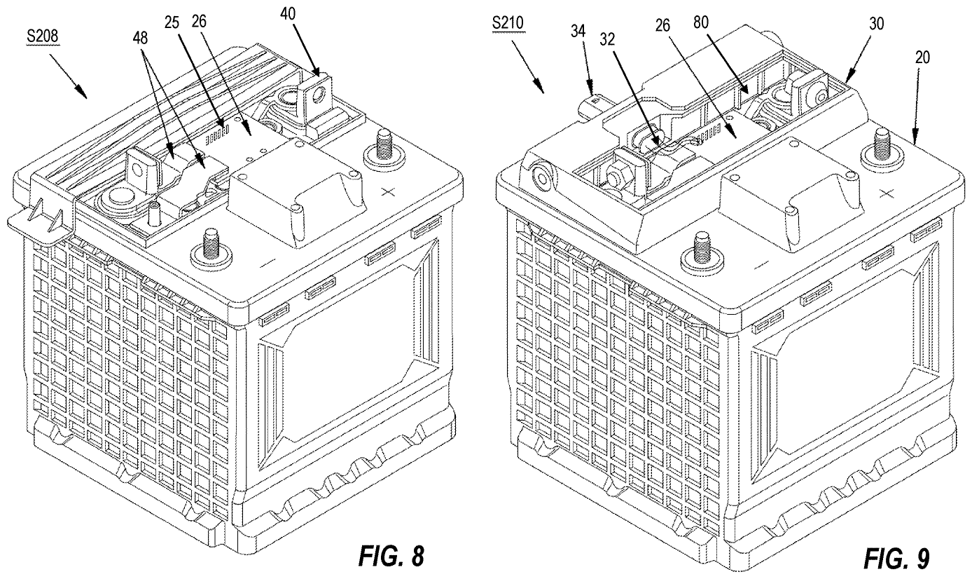

FIG. 8 shows other electronic assembly steps of the example battery manufacturing process according to the principles of the present disclosure. At step S208, BMS 26 is connected to one or more components of battery 10. Connecting BMS 26 to one or more components of battery 10 may include placing BMS 26 on lead assembly 24 and/or connecting BMS 26 to: a terminal 40 (e.g., negative terminal) of battery 10 using fasteners 28 and busbars 48; one or more components of lead assembly 24 (e.g., leads 25 of lead assembly 24, a BMS connector of lead assembly 24, etc.); and/or any other component to form an electrical/physical connection. In this nonlimiting example, BMS 26 may be electrically connected (e.g., using one fastener 28 and a busbar 48) to a negative terminal of the battery 10 and physically/mechanically coupled to first cover 20 (using another busbar 48 and another fastener 28 already coupled to first cover 20).

Step S208 may be performed after step S206. In some embodiments, step S208 may be part of step S104 of FIG. 3.

FIG. 9 shows some other electronic assembly steps of the example battery manufacturing process according to the principles of the present disclosure. At step S210, in-process cover 52 may be removed and/or second cover 30 may be coupled to or sealed to first cover 20 of battery 10. Second cover 30 may have an access opening 80 arranged for providing access to the interior of second cover 30 (e.g., to access BMS 26, lead assembly 24, etc.). Wiring harness 32 may be connected to BMS 26, e.g., using a pig-tail of the wiring harness 32 and/or vehicle connector 34. Step S210 may be performed after step S208. In some embodiments, step S210 may be part of step S104 of FIG. 3.

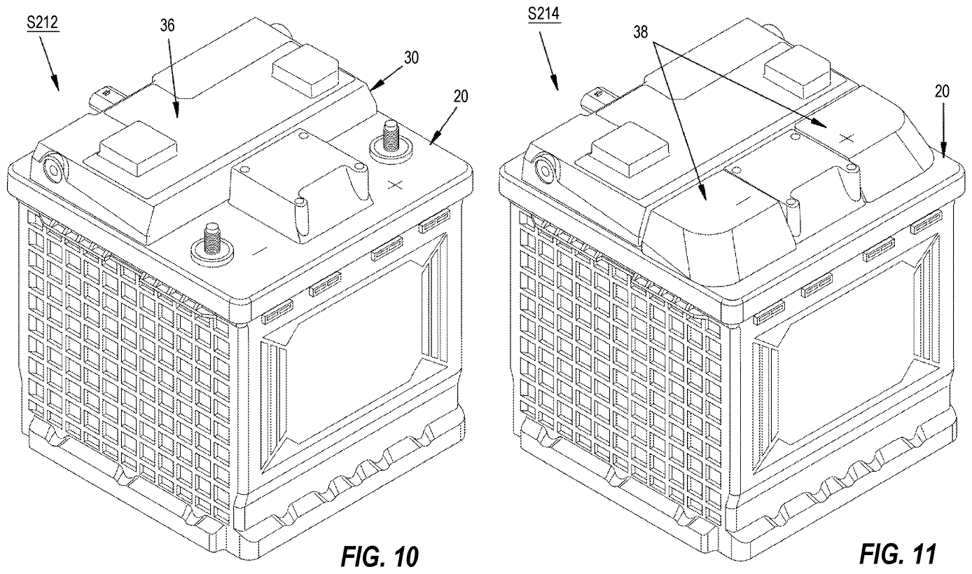

FIG. 10 shows example cover assembly steps of the example battery manufacturing process according to the principles of the present disclosure. At step S212, third cover 36 may be coupled to second cover 30 (and/or access opening 80). Coupling third cover 36 to second cover 30 (and/or access opening 80) may include sealing third cover 36 to second cover 30 (and/or access opening 80) using a heating process such as laser welding. Step S212 may be performed after step S210. In some embodiments, step S212 may be part of step S104 of FIG. 3.

FIG. 11 shows other cover assembly steps of the example battery manufacturing process according to the principles of the present disclosure. At step S214, one or more terminal caps 38 are coupled to first cover 20, which may include covering one or more terminal posts 42 (shown in FIG. 10). Step S214 may be performed after step S212. In some embodiments, step S214 may be part of step S104 of FIG. 3.

In some embodiments, one or more of the steps described herein may include one or more steps associated with pre-stuffing, stuffing, connections (e.g., mini-post/post based intercell connections), welding (e.g., electric fusion welding, intercell welding), and/or any other step.

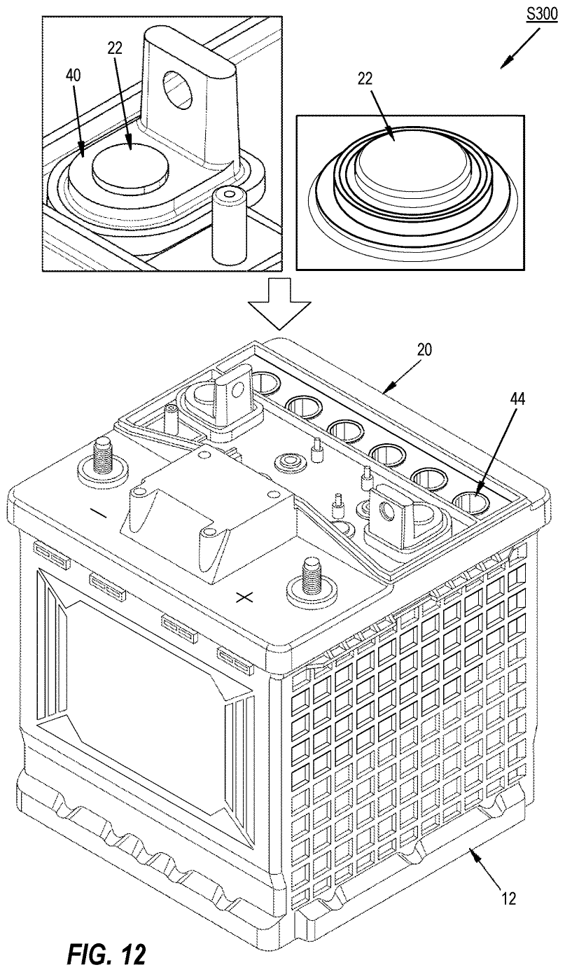

FIGS. 12-17 show another embodiment of the battery manufacturing process. One or more steps shown in FIGS. 12-17 may be similar and/or correspond to one or more steps of FIGS. 5-11. Some steps of the example battery manufacturing process associated with FIGS. 12-17 may be similar and/or correspond to other figures, e.g., FIG. 3.

More specifically, FIG. 12 shows another example battery manufacturing process including other assembly steps according to the principles of the present disclosure. The process may include, at step S300, placing and/or securing first cover 20 on case 12. Cover 20 may be aligned with at least one edge of casing 12. One or more bushings 22 may be coupled, c.g., onc bushing 22 (mini-bushing) coupled to a corresponding opening on first cover 20 (and/or post 18 such as a mini post) and/or another bushing 22 (e.g., Ul bushing) coupled to another opening on first cover 20 and to terminal 40 (and corresponding post 18 such as a terminal post). Coupling may include electrically coupling and/or physically coupling. In addition, first cover 20 may include one or more cover openings 44. Step S300 may be performed after one or more battery cells 14 are provided (e.g., similar to step S200). In some embodiments, step S300 may be part of S100 of FIG. 3.

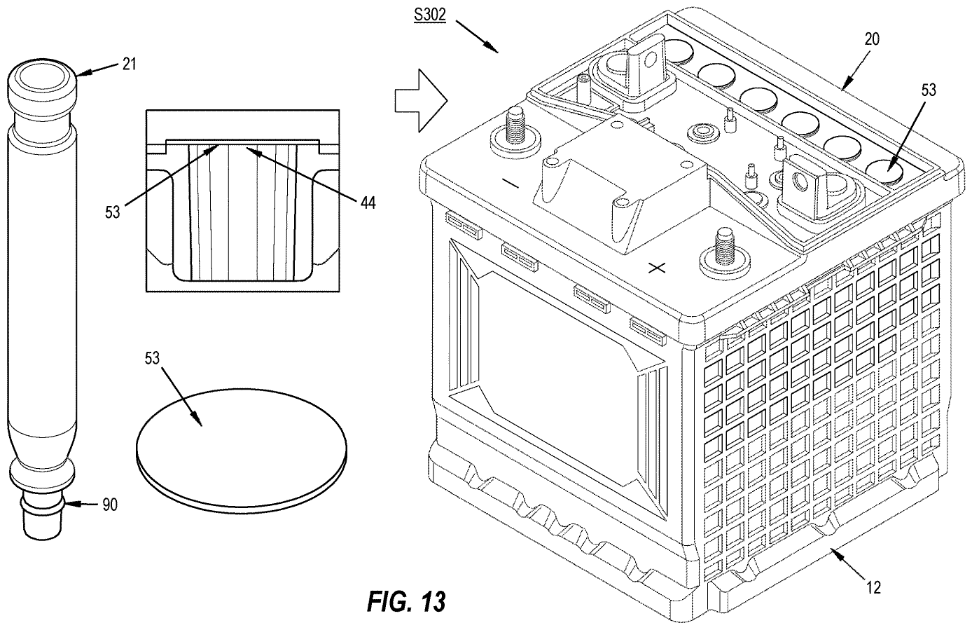

FIG. 13 shows filling and formation steps of the example battery manufacturing process according to the principles of the present disclosure. At step S302, one or more bottles 21, i.e., liquid containers, may be inserted in one or more cover openings 44 (shown in FIG. 12) and/or the contents of the bottles 21 (e.g., an electrolyte such as sulfuric acid) may be discharged (e.g., dispensed, poured, etc.) into the interior of case 12 where battery cells 14 are housed. At least one bottle 21 may include a seal 90 (e.g., o-ring). Seal 90 may be arranged to exert a bias pressure against opening 44 when bottle 21 is inserted in opening 44 and/or to prevent the contents of the bottle from spilling or discharging outside battery 10. Step S204 may further include removing the bottles 21 and/or placing cover 53 on first cover 20. In some embodiments, cover 53 is a film. The film may be a barrel film. In a nonlimiting example, the barrel film may be a 0.5 mm thick barrel film. However, the barrel film may have any other thickness. Further, cover 53 may be shaped to conform to the shape of openings 44, e.g., have a disk shape to conform to the circular shape of openings 44. Placing cover 53 on first cover 20 may include covering and/or sealing openings 44, e.g., to isolate the contents of case 12 (e.g., acid) from the exterior, to prevent the acid from spilling out of case 12, prevent matter to enter case 12 while battery 10 is being manufactured, etc. Step S302 may be performed after step S300. In some embodiments, step S302 may be part of step S102 of FIG. 3.

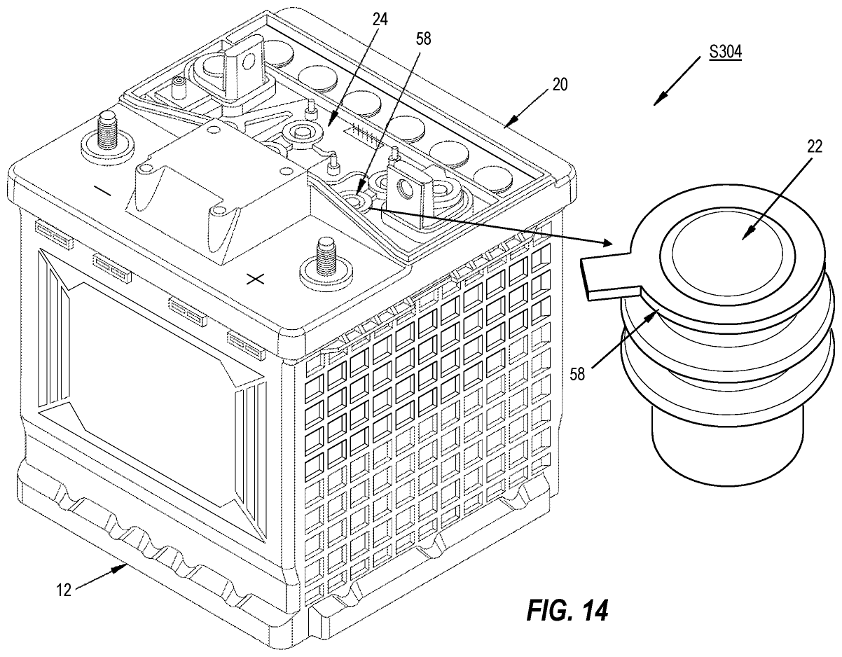

FIG. 14 shows electronic assembly steps of the example battery manufacturing process according to the principles of the present disclosure. At step S304, lead assembly 24 may be placed on first cover 20 and/or connected to at least one post 18. Placing lead assembly 24 on first cover 20 and/or connecting lead assembly 24 to at least one post 18 may include aligning lead assembly 24 with one or more components of battery 10, e.g., posts 18, and/or inserting (and/or coupling to) one or more portions of lead assembly 24 in one or more components of battery 10 (c.g., first cover 20) and/or vice versa. Step S304 may further include coupling ring 58 of lead assembly 24 to a corresponding bushing 22. Step S304 may be performed after step S302. In some embodiments, step S304 may be part of step S104 of FIG. 3.

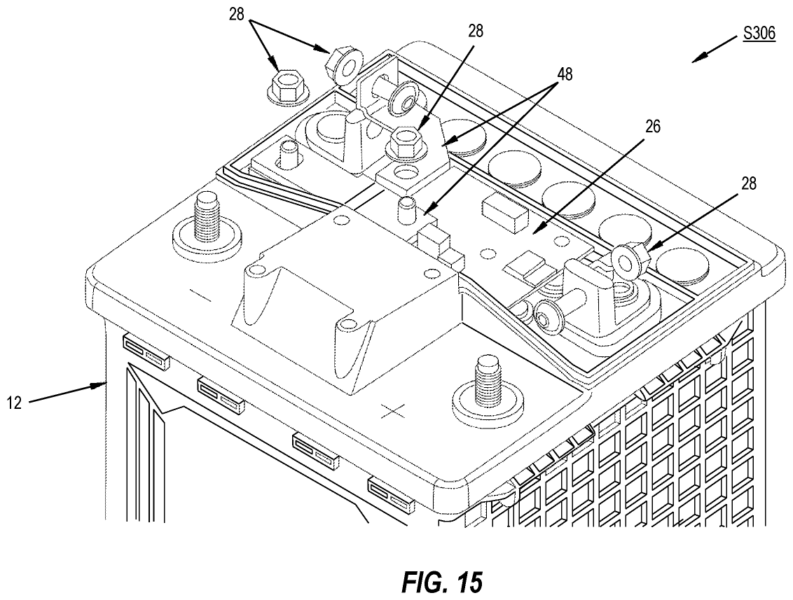

FIG. 15 shows other electronic assembly steps of the example battery manufacturing process according to the principles of the present disclosure. At step S306, BMS 26 is connected to one or more components of battery 10. Connecting BMS 26 to one or more components of battery 10 may include placing BMS 26 on lead assembly 24 and/or connecting BMS 26 to: a terminal 40 (e.g., negative terminal) of battery 10 using fasteners 28 and busbars 48; to one or more components of lead assembly 24 (e.g., a lead of lead assembly 24, a BMS connector of lead assembly 24, etc.); and/or any other component to form an electrical/physical connection. At least one of busbars 48 may be arranged to conform to a terminal shape, and the method may further include aligning the busbar 48 to the terminal and coupling the busbar 48 to the terminal. In this nonlimiting example, BMS 26 may be electrically connected (e.g., using one fastener 28 and a busbar 48) to a negative terminal of the battery 10 and physically/mechanically coupled to first cover 20 (using another busbar 48 and another fastener 28 already coupled to first cover 20). Step S306 may be performed after step S304. In some embodiments, step S306 may be part of step S104 of FIG. 3.

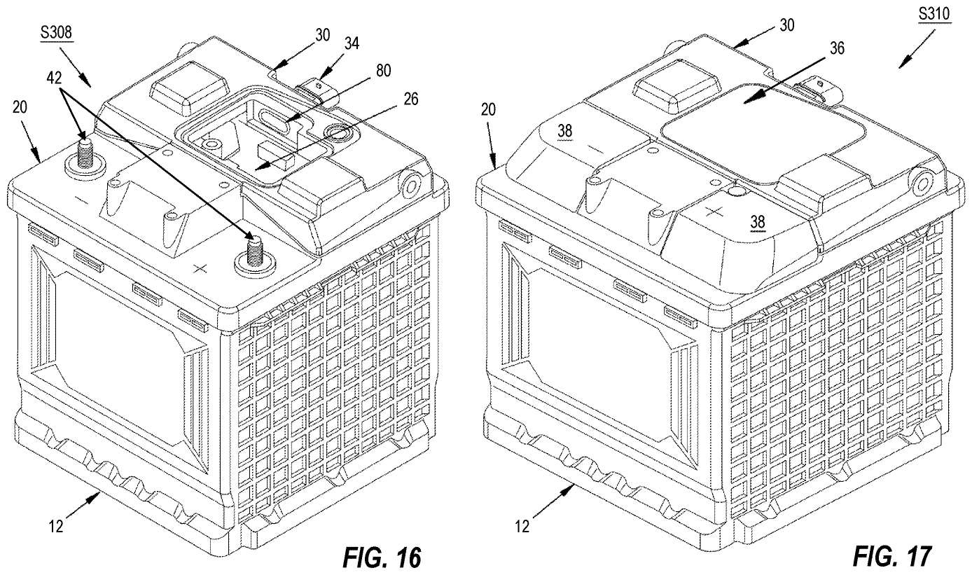

FIG. 16 shows some other electronic assembly steps of the example battery manufacturing process according to the principles of the present disclosure. At step S308, cover 53 (shown in FIG. 15) may be removed and/or second cover 30 may be coupled to first cover 20 of battery 10. Wiring harness 32 (not shown) may be connected to BMS 26, e.g., using a pig-tail of the wiring harness 32 and/or vehicle connector 34. Second cover 30 may include access opening 80. Step S308 may be performed after step S306. In some embodiments, step S308 may be part of step S104 of FIG. 3.

FIG. 17 shows example cover assembly steps of the example battery manufacturing process according to the principles of the present disclosure. At step S310, third cover 36 may be coupled to second cover 30 (and/or access opening 80). Coupling third cover 36 to second cover 30 (and/or access opening 80) may include sealing third cover 36 to second cover 30 (and/or access opening 80) using a heating process. At step S310, one or more terminal caps 38 may be coupled to first cover 20, which may include covering one or more terminal posts 42. Step S310 may be performed after step S308. In some embodiments, step S310 may be part of step S104 of FIG. 3.

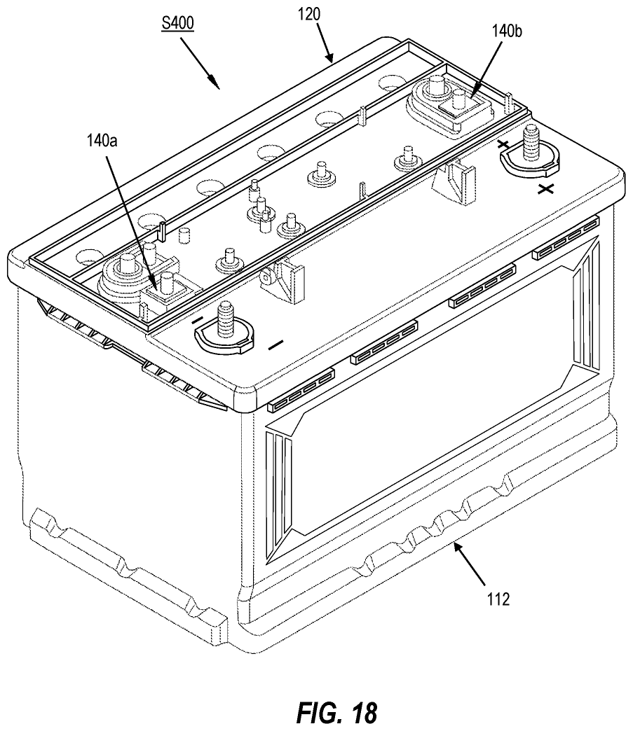

FIG. 18 shows an example assembly steps of the example battery manufacturing process according to the principles of the present disclosure. The process may include, at step S400, placing and/or securing first cover 120 on case 112. First cover 120 may include terminals 140a, 140b (collectively referred to as terminal 140). Step S400 may be similar to S202, and terminal 140 being coplanar to first cover 120 and may be different from terminals 40 (of FIG. 5), which include a portion that is not coplanar with first cover 20. Having a coplanar terminal 140 may be beneficial to reduce the required size of a second cover that is coupled to first cover 120.

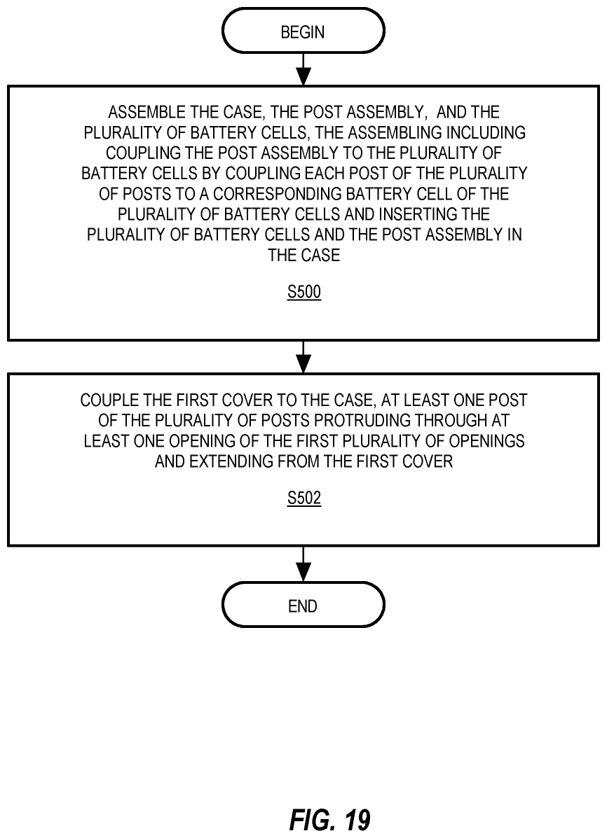

FIG. 19 shows an example method of assembling battery 10 according to some embodiments of the present disclosure. The battery 10 has a case 12, a post assembly 15, a plurality of battery cells 14, and a first cover 20. The post assembly 15 includes a plurality of posts 18. The first cover 20 has a first plurality of openings. The method includes assembling (Block S500) the case 12, the post assembly 15, and the plurality of battery cells 14. The assembling includes coupling the post assembly 15 to the plurality of battery cells 14 by coupling each post 18 of the plurality of posts 18 to a corresponding battery cell 14 of the plurality of battery cells 14 and inserting the plurality of battery cells 14 and the post assembly 15 in the case 12. The method further includes coupling (Block S502) the first cover 20 to the case 12. At least one post 18 of the plurality of posts 18 protrudes through at least one opening of the first plurality of openings and extends from the first cover 20.

In some embodiments, the method further includes performing a filling of the battery 10.

In some other embodiments, the first cover 20 further includes a second plurality of openings 44, and performing the filling of the battery 10 includes inserting one or more bottles 21 in one or more openings 44 of the second plurality of openings 44 and discharging bottle contents into the case 12.

In some embodiments, performing the filling of the battery 10 further includes removing the one or more bottles 21 and covering the plurality of second openings 44.

In some other embodiments, the battery further includes a lead assembly 24, and the method further includes at least one of placing the lead assembly 24 on the first cover 20 and coupling the lead assembly 24 to the at least one post 18 of the plurality of posts 18.

In some embodiments, the battery further includes a battery management system (BMS) 26 and one or more terminals 40. The method further includes placing the BMS 26 on the battery 10 and coupling the BMS 26 to the at least one of one or more terminals 40 and to the lead assembly 24.

In some other embodiments, the lead assembly 24 includes a plurality of leads 25, each lead 25 comprising a first end and a second end opposite the first end, and coupling the lead assembly 15 to the at least one post 18 includes coupling the first end of at least one lead 25 to the at least one post 18, and coupling the BMS 26 to the lead assembly 24 includes coupling the second end of the at last one lead 25 to the BMS 26.

In some embodiments, the battery 10 further includes a wiring harness 32 and a vehicle connector 34, and the method further includes connecting the wire harness 32 to the BMS 26 and to the vehicle connector 34.

In some other embodiments, the battery 10 further includes a second cover 30, and the method further includes coupling the second cover 30 to first cover 20.

In some embodiments, the battery 10 further includes a third cover 36 and one or more terminal caps 38. The second cover 30 includes an access opening 80. The method further includes at least one of coupling the third cover 36 to the second cover 30, where the third cover 36 covers the access opening 80 of the second cover 30, sealing the third cover 36 to second cover 30; and coupling the one or more terminal caps 38 to the first cover 20.

In some other embodiments, the battery 10 is a lead acid battery.

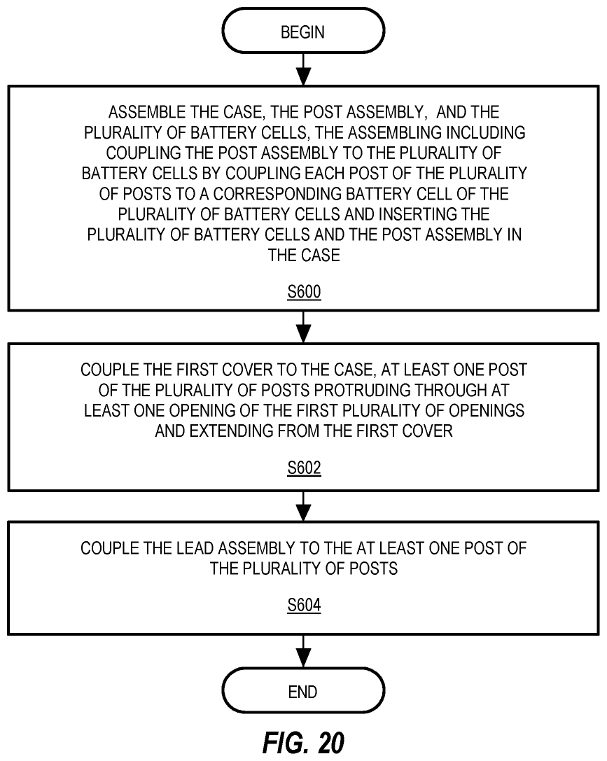

FIG. 20 shows an example method of assembling battery 10 according to some embodiments of the present disclosure. The battery 10 has a case 12, a post assembly 15, a plurality of battery cells 14, a lead assembly 24, and a first cover 20. The post assembly 15 includes a plurality of posts 18. The first cover 20 has a first plurality of openings. The method includes assembling (Block S600) the case 12, the post assembly 15, and the plurality of battery cells 14. The assembling includes coupling the post assembly 15 to the plurality of battery cells 14 by coupling each post 18 of the plurality of posts 18 to a corresponding battery cell 14 of the plurality of battery cells 14 and inserting the plurality of battery cells 14 and the post assembly 15 in the case 12. The method further includes coupling (Block S602) the first cover 20 to the case 12. At least one post 18 of the plurality of posts 18 protrudes through at least one opening of the first plurality of openings and extends from the first cover 20. In addition, the method includes coupling (Block S604) the lead assembly 24 to the at least one post 18 of the plurality of posts 18.

In some embodiments, the method further includes performing a filling of the battery 10.

In some other embodiments, the first cover 20 further includes a second plurality of openings 44, and performing the filling of the battery 10 includes at least one of inserting one or more bottles 21 in one or more openings 44 of the second plurality of openings 44, discharging bottle contents into the case 12, removing the one or more bottles 21, and covering the plurality of second openings 44.

In some embodiments, the battery further includes a battery management system (BMS) 26 and one or more terminals 40. The method further includes placing the BMS 26 on the battery 10 and coupling the BMS 26 to the at least one of one or more terminals 40 and to the lead assembly 24.

In some other embodiments, the lead assembly 24 includes a plurality of leads 25, each lead 25 comprising a first end and a second end opposite the first end, and coupling the lead assembly 15 to the at least one post 18 includes coupling the first end of at least one lead 25 to the at least one post 18, and coupling the BMS 26 to the lead assembly 24 includes coupling the second end of the at last one lead 25 to the BMS 26.

In some embodiments, the battery 10 further includes a wiring harness 32 and a vehicle connector 34, and the method further includes connecting the wire harness 32 to the BMS 26 and to the vehicle connector 34.

In some other embodiments, the battery 10 further includes a second cover 30, and the method further includes coupling the second cover 30 to first cover 20.

In some embodiments, the battery 10 further includes a third cover 36 and one or more terminal caps 38. The second cover 30 includes an access opening 80. The method further includes at least one of coupling the third cover 36 to the second cover 30, where the third cover 36 covers the access opening 80 of the second cover 30, sealing the third cover 36 to second cover 30; and coupling the one or more terminal caps 38 to the first cover 20.

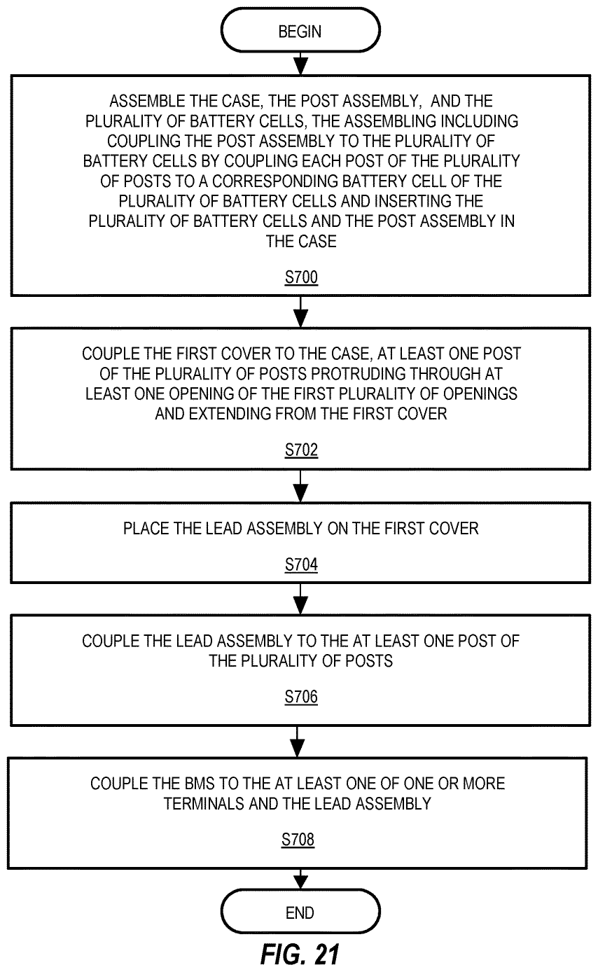

FIG. 21 shows an example method of assembling battery 10 according to some embodiments of the present disclosure. The battery 10 has a case 12, a post assembly 15, a plurality of battery cells 14, a lead assembly 24, a battery management system (BMS) 26, one or more terminals 40, and a first cover 20. The post assembly 15 includes a plurality of posts 18. The first cover 20 has a first plurality of openings. The method includes assembling (Block S700) the case 12, the post assembly 15, and the plurality of battery cells 14. The assembling includes coupling the post assembly 15 to the plurality of battery cells 14 by coupling each post 18 of the plurality of posts 18 to a corresponding battery cell 14 of the plurality of battery cells 14 and inserting the plurality of battery cells 14 and the post assembly 15 in the case 12. The method further includes coupling (Block S702) the first cover 20 to the case 12. At least one post 18 of the plurality of posts 18 protrudes through at least one opening of the first plurality of openings and extends from the first cover 20. In addition, the method includes placing (Block S704) the lead assembly 24 on the first cover 20, coupling (Block S706) the lead assembly 24 to the at least one post 18 of the plurality of posts 18, and coupling (Block S708) the BMS 26 to the at least one of one or more terminals 40 and to the lead assembly 24.

The embodiments of the present disclosure are beneficial at least because each battery cell 14 may be electrically coupled to a BMS 26, such as via posts 18, bushings 22, leads 25, etc. That is, BMS 26 of the assembled battery 10 may be configured to measure at least one parameter of each individual battery cell 14. The parameters may be used by BMS 26 to determine performance and/or predict/monitor failure of one or more battery cells 14 of the lead acid battery 10. Further, state of health of the individual battery cells may be determined and predicted.

It will be appreciated by persons skilled in the art that the present embodiments may be not limited to what may have been particularly shown and described. In addition, unless mention was made above to the contrary, it should be noted that all of the accompanying drawings may be not to scale. A variety of modifications and variations may be possible in light of the above teachings and following claims.

1. A method for assembling a battery, the battery having a case, a post assembly, a plurality of battery cells, and a first cover, the post assembly including a plurality of posts, the first cover having a first plurality of openings, the method comprising:
assembling the case, the post assembly, and the plurality of battery cells, the assembling including:
coupling the post assembly to the plurality of battery cells by coupling each post of the plurality of posts to a corresponding battery cell of the plurality of battery cells; and
inserting the plurality of battery cells and the post assembly in the case; and
coupling the first cover to the case, at least one post of the plurality of posts protruding through at least one opening of the first plurality of openings and extending from the first cover.

2. The method of claim 1, wherein the method further includes:
performing a filling of the battery.

3. The method of claim 2, wherein the first cover further includes a second plurality of openings, and performing the filling of the battery includes:
inserting one or more bottles in one or more openings of the second plurality of openings; and
discharging bottle contents into the case.

4. The method of claim 3, wherein performing the filling of the battery further includes:
removing the one or more bottles; and
covering the plurality of second openings.

5. The method of claim 1, wherein the battery further includes a lead assembly, and the method further includes at least one of:
placing the lead assembly on the first cover; and
coupling the lead assembly to the at least one post of the plurality of posts.

6. The method of claim 5, wherein the battery further includes a battery management system, BMS, one or more terminals, and the method further includes:
placing the BMS on the battery; and
coupling the BMS to the at least one of one or more terminals and to the lead assembly.

7. The method of claim 6, wherein the lead assembly includes a plurality of leads, each lead comprising a first end and a second end opposite the first end, and coupling the lead assembly to the at least one post includes coupling the first end of at least one lead to the at least one post, and coupling the BMS to the lead assembly includes coupling the second end of the at last one lead to the BMS.

8. The method of claim 6, wherein the battery further includes a wiring harness and a vehicle connector, and the method further includes:
connecting the wire harness to the BMS and to the vehicle connector.

9. The method of claim 1, wherein the battery further includes a second cover, and the method further includes:
coupling the second cover to first cover.

10. The method of claim 9, wherein the battery further includes a third cover and one or more terminal caps the second cover includes an access opening, and the method further includes at least one of:
coupling the third cover to the second cover, the third cover covering the access opening of the second cover;
sealing the third cover to second cover; and
coupling the one or more terminal caps to the first cover.

11. The method of claim 1, wherein the battery is a lead acid battery.

12. A method for assembling a battery, the battery having a case, a post assembly, a plurality of battery cells, a lead assembly, and a first cover, the post assembly including a plurality of posts, the first cover having a first plurality of openings, the method:
assembling the case, the post assembly, and the one or more battery cells, the assembling including:
coupling the post assembly to the plurality of battery cells by coupling each post of the plurality of posts to a corresponding battery cell of the plurality of battery cells; and
inserting the plurality of battery cells and the post assembly in the case;
coupling the first cover to the case, at least one post of the plurality of posts protruding through at least one opening of the first plurality of openings and extending from the first cover; and
coupling the lead assembly to the at least one post of the plurality of posts.

13. The method of claim 12, wherein the method further includes:
performing a filling of the battery.

14. The method of claim 13, wherein the first cover further includes a second plurality of openings, and performing the filling of the battery includes at least one of:
inserting one or more bottles in one or more openings of the second plurality of openings;
discharging bottle contents into the case;
removing the one or more bottles; and
covering the plurality of second openings.

15. The method of claim 12, wherein the battery further includes a battery management system, BMS, one or more terminals, and the method further includes:
placing the BMS on the battery; and
coupling the BMS to the at least one of one or more terminals and to the lead assembly.

16. The method of claim 15, wherein the lead assembly includes a plurality of leads, each lead comprising a first end and a second end opposite the first end, and coupling the lead assembly to the at least one post includes coupling the first end of at least one lead to the at least one posts, and coupling the BMS to the lead assembly includes coupling the second end of the at last one lead to the BMS.

17. The method of claim 15, wherein the battery further includes a wiring harness and a vehicle connector, and the method further includes:
connecting the wire harness to the BMS and to the vehicle connector.

18. The method of claim 17, wherein the battery further includes a second cover, and the method further includes:
coupling the second cover to first cover.

19. The method of claim 18, wherein the battery further includes a third cover and one or more terminal caps, the second cover includes an access opening, the method further includes at least one of:
coupling the third cover to the second cover, the third cover covering the access opening of the second cover;
sealing the third cover to second cover; and
coupling the one or more terminal caps to the first cover.

20. A method for assembling a battery, the battery having a case, a post assembly, a plurality of battery cells, a lead assembly, a battery management system, BMS, one or more terminals, and a first cover, the post assembly including a plurality of posts, the first cover having a first plurality of openings, the method comprising:
assembling the case, the post assembly, and the one or more battery cells, the assembling including:
coupling the post assembly to the plurality of battery cells by coupling each post of the plurality of posts to a corresponding battery cell of the plurality of battery cells; and
inserting the plurality of battery cells and the post assembly in the case;
coupling the first cover to the case, at least one post of the plurality of posts protruding through at least one opening of the first plurality of openings and extending from the first cover;
placing the lead assembly on the first cover;
coupling the lead assembly to the at least one post of the plurality of posts; and
coupling the BMS to the at least one of one or more terminals and to the lead assembly.
